(19) United States
(12) Patent Application Publication
(10) Pub. No.: US 2023/0311039 A1
(43) Pub. Date: Oct. 5, 2023

(54) ADVANCED FILTRATION STRUCTURES FOR MASK AND OTHER FILTER USES

(71) Applicant: UNIVERSITY OF NORTH TEXAS, DENTON, TX (US)

(72) Inventor: Jingbiao Cui, Frisco, TX (US)

(21) Appl. No.: 18/193,735

(22) Filed: Mar. 31, 2023

Related U.S. Application Data
(60) Provisional application No. 63/362,462, filed on Apr. 5, 2022.

(51) Int. Cl. B01D 39/20; B01D 39/16

(52) U.S. Cl. CPC B01D 39/2048; B01D 39/163; B01D 2239/025; B01D 2239/1233; B01D 2239/1225; B01D 2239/0492; B01D 2239/10; A62B 23/025

(57) ABSTRACT

In one aspect, the disclosure relates to filtration layers comprising nanostructures, methods of making the same, and devices incorporating the same. In one aspect, the filtration layers allow for air flow while blocking passage of sub-micron-sized particles including viruses and environmental pollutants. In another aspect, the filtration layers are biocompatible, flexible, stable over a wide temperature range, and compatible with standard disinfection techniques. This abstract is intended as a scanning tool for purposes of searching in the particular art and is not intended to be limiting of the present disclosure.

### CROSS-REFERENCE TO RELATED APPLICATIONS

This application claims the benefit of U.S. Provisional Application No. 63/362,462, filed on Apr. 5, 2022, which is incorporated herein by reference in its entirety.

### BACKGROUND

Adequate filtration of particulate debris from air samples is a global public health concern, in particular particles <2.5 μm. In a normal year it is estimated that 8.9 million deaths occur annually from the inhalation of small particles. In the past two years there have been over 6 million deaths due to the Covid-19 pandemic. As the pandemic progresses, infection rates continue to increase. Further infections can be in part mitigated by the use of face coverings, however, the use of surgical face masks and N95 masks may not be adequate. The N95 mask is rated to be 95% effective at capturing particles above 0.3 μm, which is still large enough to allow viral particles to pass through the filter. Covid-19 viral particles range from 65-125 nm (0.065-0.125 μm), meaning N95 masks alone are insufficient for complete prevention of the spread of the virus. Methods to increase filtration efficacy while maintaining air flow are paramount for efficient performance and comfort to users. Additionally, the use of home or commercial air filtration systems can be costly and energy inefficient due to the high pressure drop required for high performance filtration. The National Institute of Occupational Safety and Health (NIOSH) has set a benchmark flow rate of 85 L/min as the target value for face masks to be comfortable for the user while not excessively impeding breathing.

In addition to Covid-19 applications, the Environmental Protection Agency (EPA) has identified many forms of particulate pollutants as hazardous. Particulates <10 μm have been linked to lung cancer while particles <2.5 μm can penetrate the body and cause serious harm. High efficiency particulate air filters (HEPA) are effective at capturing these small particles but require high pressure drops with a large energy expenditure and are also incompatible with use as a face mask.

Current micro and nanofiber technologies can offer higher filtration efficiencies but at a reduced flow rate which makes using face masks incorporating these technologies unrealistic for most people. In many cases, these face masks simply add additional layers of material, but this severely limits airflow and, in turn, comfort. It is therefore necessary to pursue new methods of construction and new materials which can offer enhanced filtration while maintaining high flow rates for the wearer.

Surgical masks and N95 type respirators are produced from non-woven materials with the most common being polypropylene, but other polymers like polystyrene, acrylonitrile butadiene, and polyester are also frequently used. The most common technologies for fabrication of non-woven materials for masks include spunbond, melt-blown, or electrospinning. Each of these are relatively inexpensive techniques that can process a lot of material in a short amount of time. Additionally, these materials are inexpensive and offer cost effective products for mass production.

The structure of the mask or respirator often consists of multiple layers each with a unique function. For example, a surgical mask is comprised of three layers of non-woven material, while a N95 can have up to 11 layers of non-woven material, typically polypropylene. The material produced by the spunbond method offers protection against particles >0.3 μm and are used in surgical masks and the outer layer of N95 respirators. Melt-blown non-wovens are produced using a smaller fibers resulting in reduced pore size and are used for the inner layers and filter of the N95 mask.

Electrospinning methods can produce a non-woven material, electret, with electrostatic charges that offer enhanced capture of particulate through electrostatic effects. Charges on the electret also induce dipoles on uncharged particles facilitating their capture. In general, electret-based filters demonstrate a higher filtration quality factor, the ratio between particle penetration and filtration resistance, but charge dissipation is problematic. Material characteristics like dielectric factor, thermal stability, and moisture absorption capacity have a large influence on the charge capacity of the material. Because of charge dissipation, these materials have limited lifetime both in use and on the shelf. Furthermore, most electrospinning methods are still too expensive or are not commercially available at scale, however, this technology is rapidly progressing.

Despite advances in filtration research, there is still a scarcity of mask and filter materials that are effective at removing particles less than 0.3 μm in diameter, long-lasting, resistant to charge dissipation, and inexpensive to mass produce. An ideal mask and/or filtration technology would additionally allow for a comfortable level of air flow, enabling use for longer periods of time while maintaining effectiveness. These needs and other needs are satisfied by the present disclosure.

### SUMMARY

In accordance with the purpose(s) of the present disclosure, as embodied and broadly described herein, the disclosure, in one aspect, relates to filtration layers comprising nanostructures, methods of making the same, and devices incorporating the same. In one aspect, the filtration layers allow for air flow while blocking passage of sub-micron-sized particles including viruses and environmental pollutants. In another aspect, the filtration layers are biocompatible, flexible, stable over a wide temperature range, and compatible with standard disinfection techniques.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a schematic diagram of microstructure of filtration layer in masks (left), and an SEM image of an N95 mask (right).

FIGS. 2A-2B show a single fiber used in filtration layer of masks (FIG. 2A) and the fiber with nanowires grown on the side (FIG. 2B).

FIG. 3 shows a schematic of a microstructure of a filtration layer according to one embodiment of the present disclosure with nanostructures grown thereon.

FIG. 4 shows scanning electron microscopy images of nanowires (top left; scale bar 1 μm), nano-sheets (top right), branched nanowires (middle row; scale bar 100 nm), and nano-trees (bottom row; scale bar 1 μm) according to various embodiments of the present disclosure.

FIGS. 5A-5F are schematics showing two approaches to achieve the disclosed advanced filtration layer.

FIG. 6A shows a photograph of a filter layer in a mask without any nanostructures deposited, while FIGS. 6B-6C show SEM images at different magnification of the same layer.

FIGS. 7A-7F show SEM images of a filter layer in a mask after nanostructure deposition according to one embodiment of the present disclosure.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Face masks have been widely used to filter dust particles and air pollutants for general use across the world. With the challenge from respiratory pandemics such as SARS in 2003 and COVID-19, face masks play an important role in stopping the transmission of the virus. This type of physical intervention and control of the airborne transmission was recommended as early as a few centuries ago, although mask technology has been updated over time. Cloth masks were identified to control the 1910 Manchurian Plague, which is probably the first systematic use of masks during a pandemic. There is no doubt that a cloth mask can effectively stop airborne transmission and provide protection for some airborne diseases for the general population as well as health care providers, and currently, mask wearing has become a standard practice for doctors and other health care professionals.

Numerous studies on the efficacy of masks for stopping COVID-19 have also been conducted in the past several years, concluding that masks can effectively protect the wearers as well as those around them. Among various methods used to reduce the spread of respiratory viruses, masks were found to be the best performing intervention across populations, settings, and threats.

Various types of masks are commercially available such as reusable cloth masks, disposable masks, N95 masks, and so on. These masks have different capabilities in terms of filtering out the COVID-19 virus and/or other particulates. N95 and N99 are respectively classified as face masks having a filtration efficiency of 95% and 99%, respectively, for 0.3 μm particulates. If the particle size is smaller than 0.3 μm, the masks cannot filter them out effectively and may fail to protect the wearers. It is thus important to design the filtration layer with a smaller pore size in order to have high filtration efficiency for very fine particles of 0.1 μm or even smaller.

Generally speaking, the filtration layer in a mask plays a key role in physically blocking the particulates from being inhaled and therefore determining its efficacy in filtration. A filtration layer is composed of a network of randomly distributed microfibers which allow for air to pass through but not those particles larger than the size of the pores. However, the particles can still pass through if their sizes are smaller than the pores. For example, the size of SARS-CoV-2 virus is around 150 nm. In order to further improve the filtration efficiency for those small particulates, it is necessary to reduce the pore size in mask layers. In the meanwhile, it is also important to keep the efficiency of air flow, i.e. reducing air pressure drop to avoid breathing problems. Therefore, simply increasing the number of filtration layers would not work.

Disclosed herein are novel nanomaterials architectures applied to the existing filtration layers. In one aspect, the added nanostructures can significantly improve the performance of existing filter technologies such as increased filtration efficiency with reduced particle size. Due to the uniqueness of the nanostructures, high filtration efficiencies with smaller particle sizes can be achieved, compared to the current filtration structures such as N95 and N99 masks. In another aspect, the nano-material used in this design is highly stable at room temperature and even up to 300° C., which ensures the durability of the filters. In still another aspect, the filters are also flexible during practical use. In an aspect, current filtration layers can be used as backbone for the nanostructure deposition, and thus the fabrication for the nanostructures can be integrated into current production process without significant additional cost.

In still another aspect, the disclosed filtration layer is compatible with disinfection techniques and improves the filtration performance of existing technologies without significant increase in the fabrication cost. The nanomaterials used are biocompatible for day-to-day use. In one aspect, the disclosed nanostructure fabrication technique can be applied to the high-end masks like N95 to improve their protection performance for the general population as well as medical use.

Disclosed herein is a method to construct metal oxide and metal oxide composites, such as metal oxide polymer composites, for use in advanced filtration. In one aspect, the metal oxide can be, but is not limited to, a zinc oxide (ZnO) or zinc oxide polymer composite. In another aspect, the polymer can be polypropylene. In one aspect, these materials can be tailored on the nano scale to suit a particular pore size and filtration need. In another aspect, these materials are stable across a wide range of temperatures and can be derivatized with hydrophilic or hydrophobic agents to generate materials with specific properties. In a still further aspect, these materials can be constructed by a variety of methods including hydrothermal growth, electrochemical methods, sol-gel methods, or atomic layer deposition. Disclosed herein are two synthetic approaches for the construction of fibrous non-woven material 1) modification of an existing fiber network and 2) modification of the fibers prior to the construction of a non-woven. In one aspect, the architecture of the fibrous material can be altered to take different forms on the nanometer scale such as nano sheets, wires, branched wires, and nano trees. In another aspect, the pore size of these materials can range from 0.1-1 μm.

In one aspect, disclosed herein is a method for preparing a filtration layer, the method including at least the steps of:
(a) providing one or more raw fibers;
(b) depositing one or more nanostructures on the one or more raw fibers to form one or more modified fibers, wherein the nanostructures include a metal oxide, a metal oxide/polymer composite, or both; and
(c) assembling the one or more modified fibers into a fibrous network;
wherein the fibrous network forms the filtration layer.

In another aspect, disclosed herein is an alternate method for preparing a filtration layer, the method including at least the steps of:
(a) assembling one or more raw fibers into a fibrous network; and
(b) depositing one or more nanostructures on the fibrous network to form a modified fibrous network, wherein the nanostructures comprise a metal oxide, a metal oxide/polymer composite, or both;
wherein the modified fibrous network forms the filtration layer.

In one aspect, the fibrous network can be assembled using a spunbond process, a melt-blowing process, an electrospinning process, or any combination thereof. In another aspect, the one or more nanostructures can include nanowires, nanorods, nanotubes, nanofibers, nanoworms, nanocones, branched nanowires, nanoflowers, or any combination thereof. In still another aspect, the one or more nanostructures can be deposited using a hydrothermal growth process, an electrochemical process, a sol-gel process, atomic layer deposition, or any combination thereof.

In an aspect, the one or more nanostructures have a length of from about 10 nm to about 10000 nm, or of about 10, 50, 100, 150, 200, 250, 300, 350, 400, 450, 500, 550, 600, 650, 700, 750, 800, 850, 900, 950, 1000, 2000, 3000, 4000, 5000, 6000, 7000, 8000, 9000, or about 10000 nm, or a combination of any of the foregoing values, or a range encompassing any of the foregoing values. In another aspect, the one or more nanostructures can have a length of from about 1 μm to about 10 μm, or can be about 1, 2, 3, 4, 5, 6, 7, 8, 9, or about 10 μm, or a combination of any of the foregoing values, or a range encompassing any of the foregoing values.

In one aspect, the metal oxide, the metal oxide/polymer composite, or both are biocompatible. In another aspect, the metal oxide can be ZnO. In still another aspect, the metal oxide/polymer composite can be ZnO/polypropylene. Other biocompatible metal oxides and polymers are also contemplated and should be considered disclosed.

In an aspect, disclosed herein are filtration layers prepared by the disclosed methods. In one aspect, the filtration layer can block passage of at least 95% of particles less than 0.3 μm in diameter, or of at least 99% of particles less than 0.3 μm in diameter. In another aspect, the filtration layer can block passage of at least 95% of particles less than 0.1 μm in diameter, or of at least 99% of particles less than 0.1 μm in diameter.

In one aspect, the filtration layer is stable over a temperature range of from about −50° C. to about 300° C., is flexible, and is compatible with standard disinfection techniques. In another aspect, the filtration layer does not impede air flow.

In some aspects, the filtration layers disclosed herein can further include a surface coating. In one aspect, the surface coating has a thickness of from about 1 nm to about 100 nm, or of about 1, 2, 3, 4, 5, 6, 7, 8, 9, 10, 15, 20, 25, 30, 35, 40, 45, 50, 55, 60, 65, 70, 76, 80, 85, 90, 95, or about 100 nm, or a combination of any of the foregoing values, or a range encompassing any of the foregoing values. In one aspect, the surface coating can be hydrophobic or hydrophilic. In one aspect, the surface coating can be an oxide such as, for example, Al₂O₃, SiO₂, another oxide, or any combination thereof.

Also disclosed are devices including the disclosed filtration layers, including, but not limited to, masks, air filters, and the like. In another aspect, the device can be a filter for liquids including, but not limited to, water.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by,” “comprising,” “comprises,” “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of”.

As used in the specification and the appended claims, the singular forms “a,” “an” and “the” include plural referents unless the context clearly dictates otherwise. Thus, for example, reference to “a nonwoven material,” “a deposition method,” or “a hydrophobic agent,” include, but are not limited to, mixtures or combinations of two or more such nonwoven materials, deposition methods, or hydrophobic materials, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x’, ‘about y’, and ‘about z’ as well as the ranges of ‘less than x’, ‘less than y’, and ‘less than z’. Likewise, the phrase ‘about x, y, z, or greater’ should be interpreted to include the specific ranges of ‘about x,’ ‘about y,’ and ‘about z’ as well as the ranges of ‘greater than x,’ ‘greater than y,’ and ‘greater than z.’ In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, pressures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### ASPECTS

The present disclosure can be described in accordance with the following numbered Aspects, which should not be confused with the claims.

Aspect 1. A method for preparing a filtration layer, the method comprising:
(a) providing one or more raw fibers;
(b) depositing one or more nanostructures on the one or more raw fibers to form one or more modified fibers, wherein the nanostructures comprise a metal oxide, a metal oxide/polymer composite, or both; and
(c) assembling the one or more modified fibers into a fibrous network;
wherein the fibrous network forms the filtration layer.

Aspect 2. A method for preparing a filtration layer, the method comprising:
(a) assembling one or more raw fibers into a fibrous network; and
(b) depositing one or more nanostructures on the fibrous network to form a modified fibrous network, wherein the nanostructures comprise a metal oxide, a metal oxide/polymer composite, or both;
wherein the modified fibrous network forms the filtration layer.

Aspect 3. The method of aspect 1 or 2, wherein the fibrous network is assembled using a spunbond process, a melt-blowing process, an electrospinning process, or any combination thereof.

Aspect 4. The method of any one of aspects 1-3, wherein the one or more nanostructures comprise nanowires, nanotubes, nanofibers, nanoworms, nanocones, branched nanowires, or any combination thereof.

Aspect 5. The method of any one of aspects 1-4, wherein the one or more nanostructures are deposited using a hydrothermal growth process, an electrochemical process, a sol-gel process, atomic layer deposition, or any combination thereof.

Aspect 6. The method of any one of aspects 1-5, wherein the one or more nanostructures have a diameter of from about 10 nm to about 1000 nm.

Aspect 7. The method of any one of aspects 1-6, wherein the one or more nanostructures have a length of up to 1 μm.

Aspect 8. The method of any one of aspects 1-7, wherein the metal oxide, the metal oxide/polymer composite, or both are biocompatible.

Aspect 9. The method of any one of aspects 1-8, wherein the metal oxide comprises ZnO.

Aspect 10. The method of any one of aspects 1-9, wherein the metal oxide/polymer composite comprises ZnO/polypropylene.

Aspect 11. A filtration layer prepared by the method of any one of aspects 1-10.

Aspect 12. The filtration layer of aspect 11, wherein the filtration layer blocks passage of at least 95% of particles less than 0.3 μm in diameter.

Aspect 13. The filtration layer of aspect 11, wherein the filtration layer blocks passage of at least 99% of particles less than 0.3 μm in diameter.

Aspect 14. The filtration layer of aspect 11 or 12, wherein the filtration layer blocks passage of at least 95% of particles less than 1 μm in diameter.

Aspect 15. The filtration layer of aspect 11 or 12, wherein the filtration layer blocks passage of at least 99% of particles less than 1 μm in diameter.

Aspect 16. The filtration layer of any one of aspects 11-15, wherein the filtration layer is stable over a temperature range of from about −50° C. to about 300° C.

Aspect 17. The filtration layer of any one of aspects 11-16, wherein the filtration layer is flexible.

Aspect 18. The filtration layer of any one of aspects 11-17, wherein the filtration layer does not impede air flow through the filtration layer.

Aspect 19. The filtration layer of any one of aspects 11-18, wherein the filtration layer is compatible with disinfection techniques.

Aspect 20. The filtration layer of any one of aspects 11-19, further comprising a surface coating.

Aspect 21. The filtration layer of aspect 20, wherein the surface coating has a thickness of from about 1 nm to about 100 nm.

Aspect 22. The filtration layer of aspect 21, wherein the surface coating is hydrophobic or hydrophilic.

Aspect 23. The filtration layer of any one of aspects 20-22, wherein the surface coating comprises Al₂O₃, SiO₂, another oxide, or any combination thereof.

Aspect 24. A device comprising the filtration layer of any one of aspects 11-23.

Aspect 25. The device of aspect 24, wherein the device is a mask, an air filter, or a filter for liquids.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Comparison to Commercial N95 Masks and Benefits of the Disclosed Nanostructure Approach

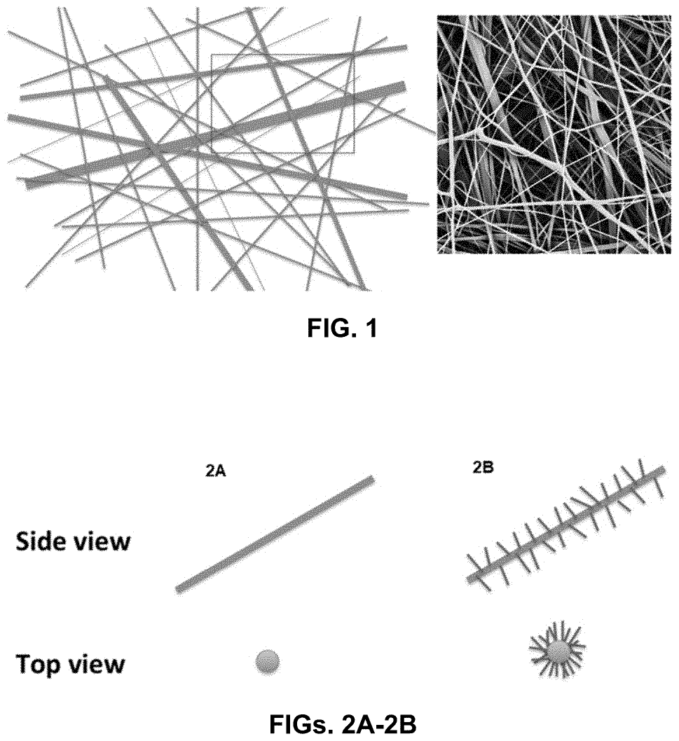

The typical microstructure of the filtration layer of a mask contains a multilayer network of random fibers, which is typically made of polypropylene nonwoven fabrics. FIG. 1 schematically shows the fiber structure of an N95 mask (left) and an actual SEM image (right). The fiber size varies from 1 to 10 micrometers. These fibers are randomly packed together to form a network with pores of different size. Those pores allow for air to pass through the filters while the particulate particles such as viruses are blocked. However, the pore size varies from submicrometers up to 10 micrometers. The filter blocks large particles effectively, but may fail to block the small particles which have size smaller than that of the pores. Though the number of large pores may be a small fraction in the filter layer, they can cause the mask to fail for certain kinds of protection. The N95 designation for many masks means they can filter out 95% of the particles with size down to 0.3 μm. Additionally, some known masks use electret to capture small particles due to the large size of the pores in the filtration layer. Other masks are meant to protect against oil-based aerosols (DOP), and the National Institute of Occupational Safety and Health has created different grades with filtration efficiencies 95-99.97% to describe these.

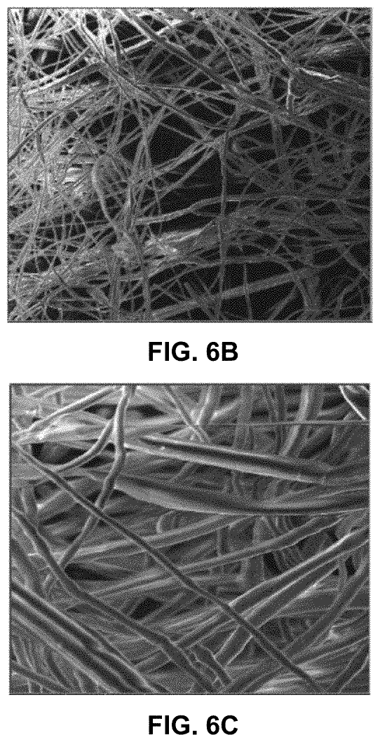

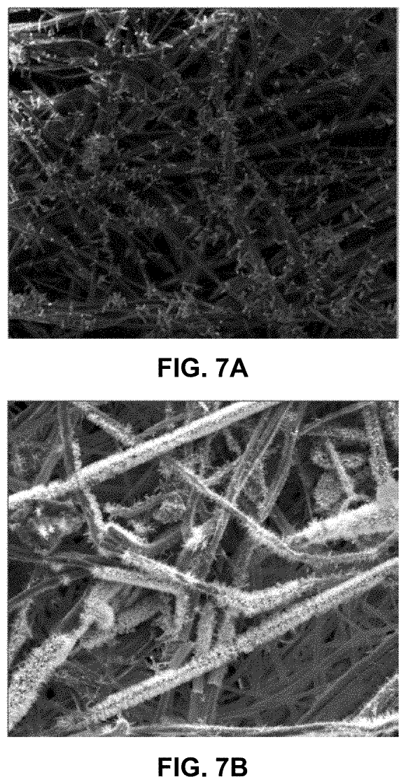

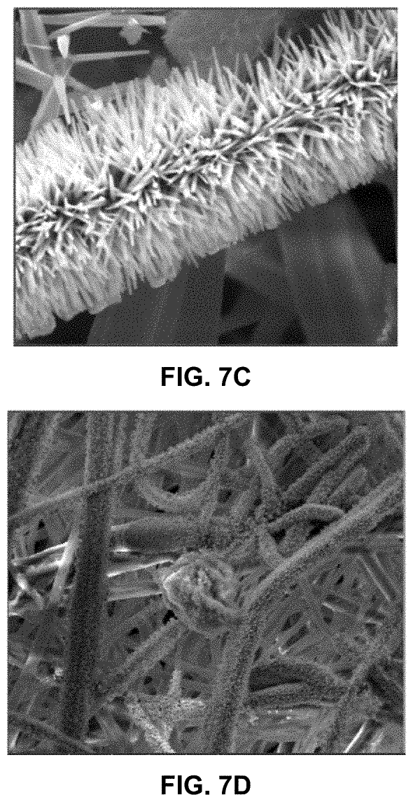

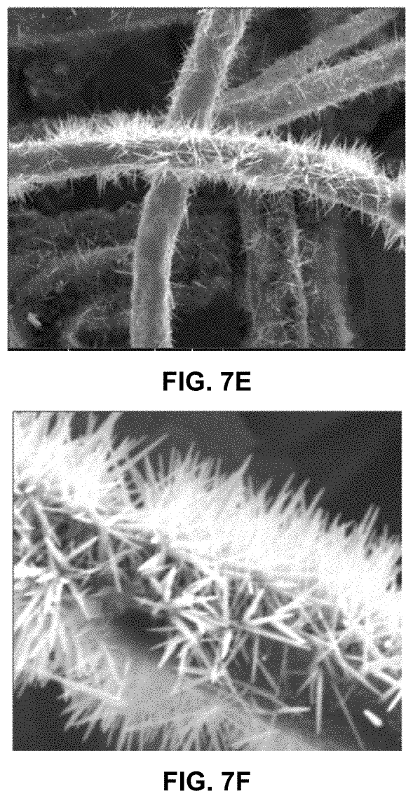

As shown in the top and cross sectional view of N95 filter layer in FIG. 1, large pores are present within the same layer and cross different layers. Those large pores form flow channels for smaller particles to pass through the filtration layer, which may cause the mask to fail at protecting its wearer in certain circumstances. An ideal filtration structure would maximize the filtration efficiency while minimizing the pressure drop. The use of multilayers can help to improve the filtration efficiency, but the flow channel with the large pores still exists in such cases. FIGS. 6A-6C show an optical image and SEM images of a current N95 mask, while FIGS. 7A-7F show SEM images of a filter layer in a mask after nanowire deposition.

The inventor has fortuitously discovered that adding advanced nanostructures to the filtration layers to reduces the effective size of the pores in the filtration layer so that the filtration efficiency can be improved for smaller particles compared to existing N95 technology. FIGS. 2A-2B illustrate the structure of individual fiber without (FIG. 2A) and with (FIG. 2B) nanowires grown on surface. The fibers with nanowires become branched fibers, which can be used as the elements for mask filtration layer.

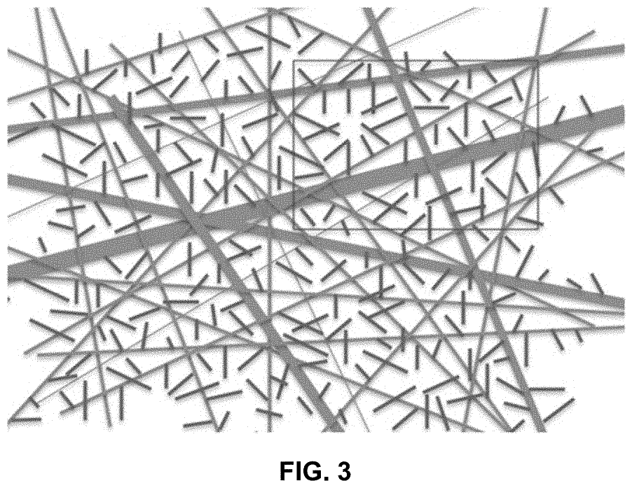

Using the branched fibers, the pore size in the fiber networks of filtration layer are significantly reduced as shown in FIG. 3. The fibers are used as the backbone for the nanowire growth. These nanowires grow in all directions, which can efficiently reduce the pore size within the filtration layers and also across the layers to minimize the possible passage for small particles to pass through. As shown in rectangular inset area of FIG. 3, those pores are reduced for improving filtration efficiency for small particulates.

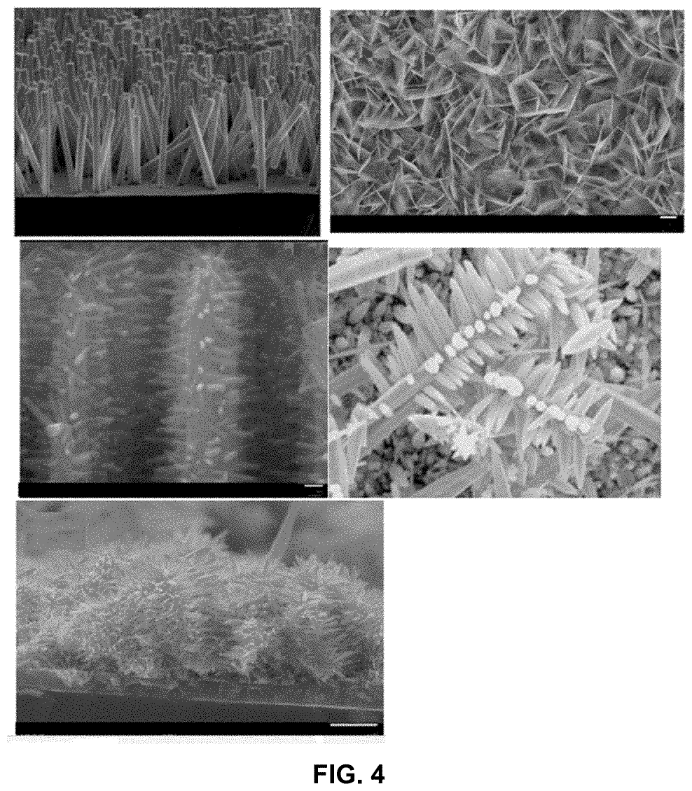

The nanostructures can be simply nanowires of tens to hundreds nanometer in diameter and up to micrometer in length, which can be tailored to meet the needs. This minimizes material use for maximum filtration efficiency. The nanostructures used to enhance the filtration efficiency are not limited in shape and can include other forms such as nanowires, nanotubes, nanofibers, nanoworms, nanocones, branched nanowires, or a combination of these as shown in FIG. 4. The nanostructures can grow directly on the fiber networks to increase filtration efficiency. Due to the small pore size and 3-dimensional blocking, the number of filtration layers can be reduced. This helps reduce use of materials and also reduces pressure drop for easy breathing.

The nanostructures shown in FIG. 4 are ZnO nanowires and branched nanowires of ZnO/Si that were generated in a laboratory setting. These materials are biocompatible and are non-toxic to humans, but other metal oxides are also acceptable for this purpose. For example, ZnO has been used in many products, including, but not limited to, sun cream to block UV light, diaper rash cream for babies, and food additives, and has been found to be safe in proximity to human skin. The nanostructures, if inhaled, do not harm the human body. Other biocompatible metal oxides can also be used.

For improving the filtration layers, coatings of a few nanometers on the surface can also be added to make the filters either hydrophobic or hydrophilic. The different surface wettability design in the multilayer filters may be helpful for improving comfort, filtration of aerosols, and moisture control for long time use.

### Example 2: Method of Making the Filtration Layer

The growth of the nanostructure can be carried by low temperature and low energy processes such as hydrothermal growth, electrochemical process, sol-gel process, atomic layer deposition, or combinations of these techniques.

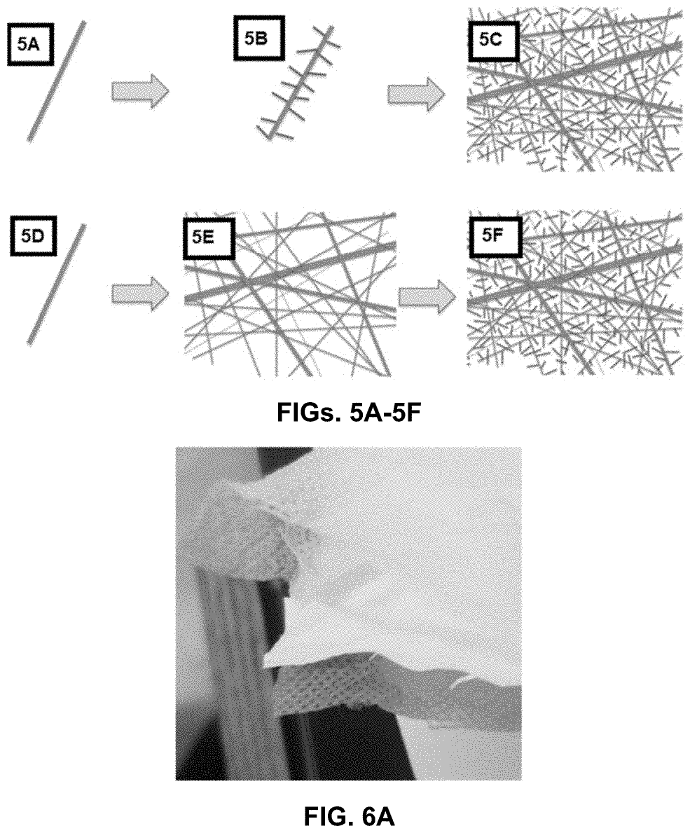

Two approaches may be developed for the filtration layer fabrication as shown in FIGS. 5A-5F. The first approach is to start with raw fiber materials (FIG. 5A), grow branched fibers first (FIG. 5B), and then assemble them into filtration networks, i.e. filtration layer (FIG. 5C). The second approach is also to start with raw fiber materials (FIG. 5D), assemble the fiber into filtration networks first, i.e. use the current mask filtration layer (FIG. 5E), and then fabricate the nanostructures on the fiber networks (FIG. 5F).

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

What is claimed is:

1. A method for preparing a filtration layer, the method comprising:
depositing one or more nanostructures on a plurality raw fibers to form one or more modified fibers, wherein the nanostructures comprise a metal oxide, a metal oxide/polymer composite, or both;
wherein the raw fibers are assembled into a fibrous network before the one or more nanostructures are deposited, or wherein the modified fibers are assembled into a fibrous network after the one or more nanostructures are deposited; and
wherein the fibrous network forms the filtration layer.

2. The method of claim 1, wherein the fibrous network is assembled using a spunbond process, a melt-blowing process, an electrospinning process, or any combination thereof.

3. The method of claim 1, wherein the one or more nanostructures comprise nanowires, nanotubes, nanofibers, nanoworms, nanocones, branched nanowires, or any combination thereof.

4. The method of claim 1, wherein the one or more nanostructures are deposited using a hydrothermal growth process, an electrochemical process, a sol-gel process, atomic layer deposition, or any combination thereof.

5. The method of claim 1, wherein the one or more nanostructures have a diameter of from about 10 nm to about 1000 nm.

6. The method of claim 1, wherein the one or more nanostructures have a length of up to 1 μm.

7. The method of claim 1, wherein the metal oxide, the metal oxide/polymer composite, or both are biocompatible.

8. The method of claim 1, wherein the metal oxide comprises ZnO.

9. The method of claim 1, wherein the metal oxide/polymer composite comprises ZnO/polypropylene.

10. A filtration layer prepared by the method of claim 1.

11. The filtration layer of claim 10, wherein the filtration layer blocks passage of at least 95% of particles less than 0.3 μm in diameter.

12. The filtration layer of claim 10, wherein the filtration layer blocks passage of at least 95% of particles less than 1 μm in diameter.

13. The filtration layer of claim 10, wherein the filtration layer is stable over a temperature range of from about −50° C. to about 300° C.

14. The filtration layer of claim 10, wherein the filtration layer is flexible.

15. The filtration layer of claim 10, further comprising a surface coating.

16. The filtration layer of claim 15, wherein the surface coating has a thickness of from about 1 nm to about 100 nm.

17. The filtration layer of claim 15, wherein the surface coating is hydrophobic or hydrophilic.

18. The filtration layer of claim 15, wherein the surface coating comprises Al₂O₃, SiO₂, another oxide, or any combination thereof.

19. A device comprising the filtration layer of claim 15.

20. The device of claim 19, wherein the device is a mask, an air filter, or a filter for liquids.
